(19) United States
(12) Patent Application Publication
(10) Pub. No.: US 2017/0198483 A1
(43) Pub. Date: Jul. 13, 2017

(54) FLOORING DECK SYSTEM

(71) Applicant: Lawrence M. JANESKY, Middlebury, CT (US)

(72) Inventor: Lawrence M. JANESKY, Middlebury, CT (US)

(21) Appl. No.: 15/469,195

(22) Filed: Mar. 24, 2017

Related U.S. Application Data
(63) Continuation of application No. 14/450,878, filed on Aug. 4, 2014.

(51) Int. Cl. E04F 15/10; B32B 3/06; B32B 27/40; E04F 15/02; B32B 5/18

(52) U.S. Cl. CPC E04F 15/107; E04F 15/02038; E04F 15/02177; B32B 5/18; B32B 27/40; B32B 3/06; E04F 2201/023; E04F 2201/0107; E04F 2203/00; B32B 2471/00

(57) ABSTRACT

A flooring deck system comprising a plurality of panels having at least two layers including a substantially rigid sheet layer of substantially inorganic material and a substantially rigid inorganic foam layer, the substantially rigid sheet layer having a flooring surface and a joining surface configured to attach to the substantially rigid inorganic foam layer, and the substantially rigid inorganic foam layer having a connecting surface configured to attach to the joining surface of the substantially rigid sheet layer, and an underside surface configured to contact a foundation floor, wherein the substantially rigid inorganic foam layer is configured to support both a static and live floor load gauged for a floor.

### CROSS-REFERENCE TO RELATED APPLICATIONS

This application is a continuation of U.S. Non-provisional patent application Ser. No. 14/450,878 filed Aug. 4, 2014, the disclosure of which is incorporated herein reference in its entirety.

### BACKGROUND

Field of Embodiments

The disclosed embodiments relate to an insulated floor system for wet and high humidity space, and more specifically to water impervious and insulated flooring deck and floor for a basement.

Description of Earlier Related Developments

In order to improve the appearance and feel of a concrete floor, most people cover them with some type of flooring system. Traditionally, to create a subfloor for the concrete floor, an installer would first put down wood “sleeper” studs. Between each stud one had the option of then placing a foam board for insulation. With or without the insulation board, the subfloor would be finished with a sheet of plywood over top of the studs concealing the floor below. With the subfloor now in place a finishing material could be applied to it to finish the floor, such as a carpet or hardwood. Typically, these subfloors were applied in a basement. In the event of a leak or water vapor penetrating the concrete floor, the subfloor being made of wood created a situation for mold and mildew growth and rot. An alternative to the “sleeper” stud plywood finishing system is to provide a free floating subfloor that consists of an upper layer and a lower layer. The upper layer being made of a sheet material such as plywood and the lower layer being made of a plastic that would not promote growth or rot. Such a system is disclosed in the U.S. Pat. No. 6,918,215. A problem with such a system arises in the fact that the plastic material provides no insulation. Accordingly, there is a desire to provide a subfloor system upon which a finished surface can be applied that does not mold or rot and that provides the insulation desired in applications with a concrete floor.

### BRIEF DESCRIPTION OF THE DRAWINGS

The foregoing aspects and other features of the disclosed embodiments are explained in the following description, taken in connection with the accompanying drawings, wherein:

FIG. 1 is an perspective view of a finished floor and underlying flooring deck system, incorporating features in accordance with the disclosed embodiment, disposed on a basement floor;

FIG. 2 is a partial perspective view of the flooring deck system in FIG. 1;

FIG. 3 is a schematic perspective view of a panel for a flooring deck system, incorporating features in accordance with the disclosed embodiment;

FIG. 4 is a bottom view of the panel in FIG. 3;

FIG. 5 is another bottom view of the panel in FIG. 3;

FIG. 6 is a block diagram schematically illustrating a method of installing a flooring deck system, incorporating features in accordance with the disclosed embodiment.

### DETAILED DESCRIPTION OF THE EXEMPLARY EMBODIMENT(S)

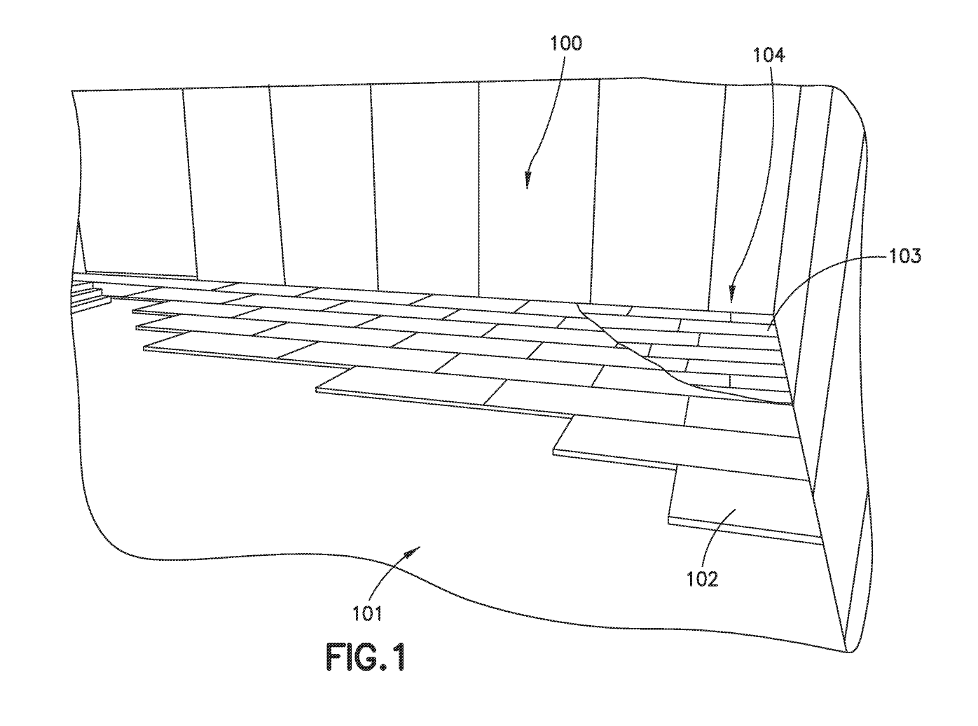

FIG. 1 illustrates a flooring deck system 100 in accordance with an aspect of the disclosed embodiment. Although the aspects of the disclosed embodiment will be described with reference to the drawings, it should be understood that the aspects of the disclosed embodiment can be embodied in many forms. In addition, any suitable size, shape or type of elements or materials could be used.

According to the aspects of the disclosed embodiment, a flooring deck system 100 for application over for example a concrete basement slab 101 is provided. Although, the flooring deck system 100 of the disclosed embodiment will be described below with specific reference to application onto a concrete basement slab 101, in alternative aspects the flooring deck system 100 may be used with, and the features of the disclosed embodiment are equally applicable to installation on any desired type of subfloor. Referring to FIG. 1, a flooring deck system 100 is shown situated on a concrete basement slab 101. The flooring deck system 100 may be used for example to finish an unfinished basement and provide a more comfortable living space. By placing the flooring deck system 100 on the concrete basement slab 101, the deck system may provide, for example, an even surface offset from the slab and suited for placement of a finishing floor material 103 creating a finished floor 104. The flooring deck system 100 may also provide a surface that a finishing floor material 103 can more easily be attached to rather than the concrete basement slab 101.

The flooring deck system 100 may also serve to insulate the finished floor 104 and the basement interior as a whole. Typically, a concrete basement slab 101 effects a heat drain from the basement interior and the basement floor feels cold to the touch. By placing the flooring deck system 100 on top of the concrete basement slab 101 this effectively insulates the finished floor 104, reducing the heat lost from the basement interior and reducing the heat loss from the finished floor 104 so that when it is walked on it will not be cold to the touch.

Generally, accumulation of water in a basement is not uncommon, with the corresponding possibility for water damage to occur. Most homes maintain pipes to provide water to the home in the basement. When a pipe bursts the water usually ends up collecting in the basement. Water may also collect in the basement through ground water penetrating the concrete basement slab 101 and basement walls. If this happens, anything and everything in the basement is subject to getting wet and in turn becoming damaged, whether it be conventional wood “sleeper” studs rotting and losing structural integrity and any other conventional finishing floor material placed on the floor becoming damaged. The flooring deck system 100 protects the finished floor 103 from water damage, as it is water impervious and elevates the finishing floor material 103 off the concrete basement slab 101 where any water would collect. The flooring deck system 100 would remain unaffected by the water that has collected while protecting anything else that may be placed upon it by creating a barrier impervious to water between the concrete basement slab 101 and the materials to be protected.

Accomplishing these aspects of the flooring deck system 100 includes providing a plurality of flooring deck panels 102 and placing them on the concrete basement slab 101 in a manner that produces a uniform flooring deck system 100. These flooring deck panels 102 include a foam layer that provides the insulation for the room and the finished floor 104. The foam layer also provide structural integrity for the panels 102 allowing them to have the load bearing capacity of a floor without being, for example, damaged or buckling when a load such as a human or furniture is applied to the flooring deck system 100.

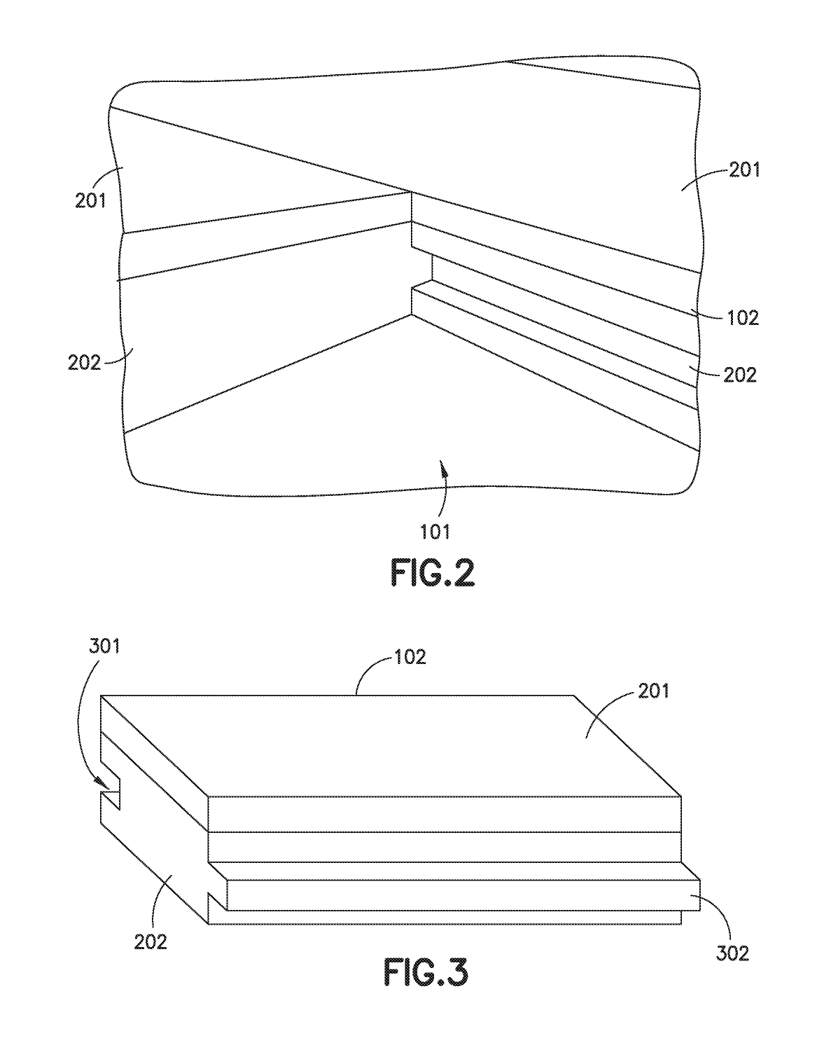

Referring now to FIG. 2, a partial view of the flooring deck system 100 is shown. The flooring deck system 100, as previously stated, includes a plurality of flooring deck panels 102. The flooring deck panels 102 include a first layer 201. The first layer 201 may be made solely of a substantially rigid sheet material such as magnesium oxide or any other suitable material including, but not limited to, substantially inorganic cement board. The first layer may alternatively be multiple layered rigid sheets or a composite layer stacked on a sheet of inorganic material to remain water impervious. The first layer 201 provides a surface where the finishing floor material 103 may be situated. The first layer 201 is generally rigid to help maintain structural integrity and prevent the finished floor 104 from bowing and buckling.

The flooring deck panel 102 also includes a second layer 202. The second layer 202 is made of a rigid foam material such as extruded polystyrene or any other suitable material including, but not limited to, expanded polystyrene, polyisocyanurate, expanded polyurethane, and extruded polyurethane. The second layer 202 is formed by cutting a block of the desired material the second layer 202 will be formed of and down to the desired size, using a hot wire cutting process or any other suitable manner in which to cut the block. The second layer 202 provides the insulative properties desired for the insulated. flooring deck system 100. The rigid foam material may vary in thickness depending on desired insulative properties, the thickness range including, but not limited to, 0.5″, 1″, 2″, and 3″. As shown in FIG. 2, the second layer 202 provides structural support to the flooring deck panel 102 by having the load capacity, for example, of a floor. As may be realized, the substantially rigid first layer may serve to distribute local loads to the second layer, and the second layer carries the floor loads to the underlying concrete basement slab 101. The floor load capacity defined by the second rigid foam layer includes both static and live loads as gauged for a floor.

The second layer 202, as previously stated, is substantially inorganic and water impervious. When any water collects between the second layer 202 and the concrete basement slab 101, coming into contact with the second layer 202, the second layer 202 not affected. The second layer 202 does not promote any growth of mildew or mold.

The flooring deck panels 102, may be formed in any suitable manner, for example, the first layer 201 and the second layer 202 may be joined together to form an integral panel. In order to join the first layer 201 to the second layer 202 any suitable methods may be utilized. These methods for example may include, but are not limited to, applying an adhesive to one or more of the rigid layers 201, 202 and joining the surfaces with adhesive together. Also, using an adhesive laminate between the two layers or a fastener may be another method to join the layers to one another.

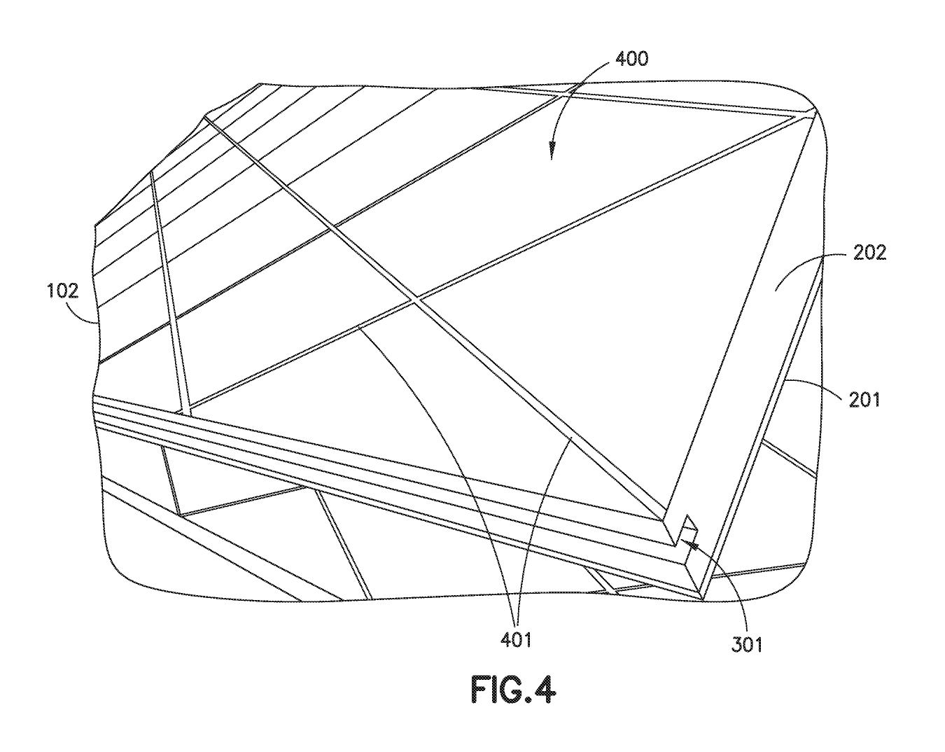

Referring now to FIG. 3, a flooring deck panel 102 is shown. When installing the flooring deck system 100 into a basement, the flooring deck panels 102 may be connected together to create one uniform flooring deck system 100. The panels may be self-connecting, incorporating an integral coupling member in each panel as will be described further below. In order to connect the flooring deck panels 102, the first layer 201 or second layer 202 may be configured with an interlocking member, for example a tongue or groove of a rabbet type coupling configuration. Either of the first layer 201 or second layer 202 may have a tongue 302 protruding on one side of the flooring deck panel 102 and a groove 301 on the opposite side as seen in FIG. 3. The coring configuration maybe molded into the second layer during its formation or alternatively, formed by removing excess material after the formation of the second layer by way of hot wire cutting or any other suitable way to remove the excess material. In an alternative aspect of the flooring deck panel 102, the flooring deck panel 102 may have a tongue 302 protruding from two adjacent or opposite sides of the flooring deck panel 102 and grooves 301 on the sides without tongues 302. The grooves 301 on each flooring deck panel 102 are configured accept any tongue 302 of a subsequent panel and the tongues 302 on each flooring deck panel 102 are configured to interface with any complementing groove 301 of a subsequent adjoining panel. When interfacing, the flooring deck panels 102 are joined together to create a uniform flat surface that, as stated previously, can support a load such as furniture or a human and can have a finishing flooring material 103 applied to it if desired. The flooring deck panels 102 may interlock via any other suitable interlocking coupling configuration. Alternatively, each flooring deck panel 102, if desired, may be placed and abutted to the wall or an adjacent panel without interlocking at all.

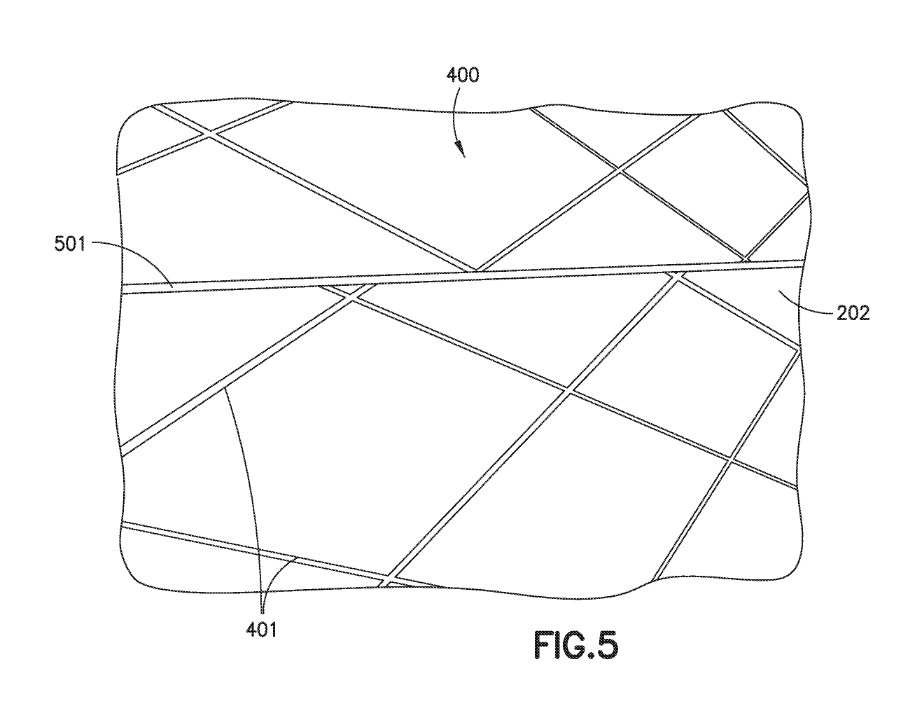

Referring now to FIG. 4, the bottom surface 400 of the second layer 202 is shown. In order to effectuate drying and draining of moisture that may collect between the concrete basement slab 101 and the second layer 202 it would be beneficial to include a way for air to circulate and the moisture to flow freely beneath the flooring deck panels 102. One way in which to achieve these aspects includes, but is not limited to, adding a global drain and vent channel 401 to the bottom surface 400. These drain and vent channels 401 would provide a passage for which air could circulate and the moisture could drain away from the flooring deck system 100 preventing it from penetrating up into the second layer 202. The drain and vent channels 401 may be added to the bottom surface 400 by notching or carving the drain and vent channels 401 into the bottom surface 400 or any other way that may be suitable for creating a channel, for example, using a hot wire to melt the channels into the bottom. The drain and vent channels 401 may traverse the entire bottom surface 400 or a portion thereof and may traverse in any manner, such as in a diamond pattern as seen in FIG. 4. Alternatively, the drain and vent channels 401 may traverse in any pattern that is suitable for effectuating the ventilation and drainage desired including, but not limited to, a square pattern.

Referring now to FIG. 5, another exemplary representation of the bottom surface 400 in shown. In this aspect, along with the drain and vent channels 401, a merging channel 501 is shown. When laying the flooring deck panels 102, in order to create a more structurally stable flooring deck system 100, it may be best to tagger the flooring deck panels 102 in a way that would not create a single long seam where the flooring deck panels 102 connect. If the flooring deck panels 102 are staggered the ends of the drain and vent channels 401 from two adjacent flooring deck panels 102 may not directly match up. This would create a situation where an installer would. have to manually line up the channels of adjacent flooring deck panels 102 to ensure that there is a continuous channel across the flooring deck system 100. Adding a merging channel 501 along a perimeter of the bottom surface 400 would enable the drain and vent channels 401 to merge and create the continuous channel and also eliminate the need for the installer to manually line up each drain and vent channel 401.

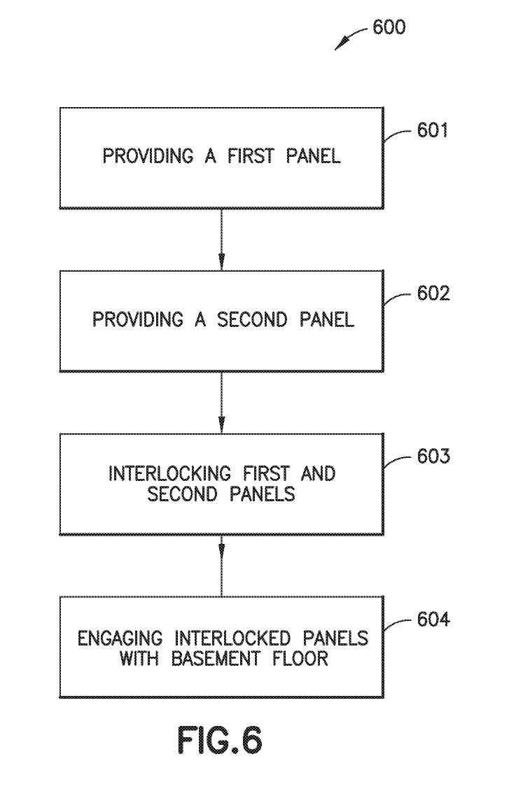

Referring now to FIG. 6, a block diagram 600 of a method of installing a flooring deck system 100 is shown. The method, as shown in block 601, includes an installer providing a first panel having first layer and a second layer joined together that is configured to support both a static and live load gauged for a floor. The method, as shown in block 602, also includes an installer providing a second panel having a first layer and a second layer joined together that is configured. to support both a static and live load gauged for a floor. The method, as shown in block 603, subsequently includes an installer then interlocking both the provided panels to form the flooring deck system 100. Finally, the method, as shown in block 604, includes the installer engaging the formed flooring deck system 100 with the concrete basement slab 101 completing the system. Alternatively, the system may include a finishing floor material 103 to finish the basement.

In accordance with one or more aspects of the disclosed embodiment a flooring deck panel is provided. The flooring deck panel comprises a first layer including a substantially rigid sheet substantially of inorganic material, the first layer having a flooring surface and a joining surface and a second layer joined to the joining surface of the first laver, the second layer being formed of a substantially rigid inorganic foam material, the second layer being configured as a subfloor support structure, with a walking floor load-bearing capacity, supporting one or more of a static and live load applied to the flooring surface of the first layer.

In accordance with one or more aspects of the disclosed embodiment, wherein the second layer is insulating foam.

In accordance with one or more aspects of the disclosed embodiment, wherein the insulating foam is at least one of extruded polystyrene foam (XPS) or expanded polystyrene foam (EPS).

In accordance with anew or more aspects of the disclosed embodiment, wherein the insulating foam is at least one of extruded polyurethane foam (XPU) or expanded polyurethane foam (EPU).

In accordance with one or more aspects of the disclosed embodiment, wherein the first layer is substantially impervious to water.

In accordance with one or more aspects of the disclosed embodiment, wherein the second layer is substantially impervious to water.

In accordance with or more aspects of the disclosed embodiment, wherein the first layer is a magnesium oxide sheet.

In accordance with anew or more aspects of the disclosed embodiment, wherein the second layer has channels traversing the underside effecting ventilation of air and moisture.

In accordance with or more aspects of the disclosed embodiment, wherein one of the channels is a merging channel

In accordance with one or more aspects of the disclosed embodiment, wherein the merging channel traverses along at least one of a perimeter effecting merging of adjacent panel channels creating a continuous channel across all panels.

In accordance with one or more aspects of the disclosed embodiment, wherein the second layer includes an interlocking member for interfacing with adjacent panels.

In accordance with one or more aspects of the disclosed embodiment a flooring deck system is provided. The flooring deck system comprises a plurality of panels having at least two layers including a substantially rigid sheet layer of substantially inorganic material and a substantially rigid inorganic foam layer, the substantially rigid sheet layer having a flooring surface and a joining surface configured to attach to the substantially rigid inorganic foam layer, and the substantially rigid inorganic foam layer having a connecting surface configured to attach the joining surface of the substantially rigid sheet layer, and an underside surface configured to contact a foundation floor, wherein the substantially rigid inorganic foam layer is configured to support both a static and live floor load gauged for a floor.

In accordance with one or more aspects of the disclosed embodiment, wherein the substantially rigid inorganic foam layer is insulating foam.

In accordance with one or more aspects of the disclosed embodiment, wherein the insulating foam is at least one of extruded polystyrene foam (XPS) or expanded polystyrene foam (EPU).

In accordance with one or more aspects of the disclosed embodiment, wherein the insulating foam is at least one of extruded polyurethane foam (XPU) or expanded polyurethane foam (EPU).

In accordance with one or more aspects of the disclosed embodiment, wherein the substantially rigid inorganic foam layer is substantially impervious to water.

In accordance with or more aspects of the disclosed embodiment, wherein the substantially rigid sheet layer is magnesium oxide.

In accordance with one or more aspects of the disclosed embodiment, wherein the substantially rigid inorganic foam layer has a global drain and vent channel traversing the underside surface.

In accordance with one or more aspects of the disclosed embodiment, wherein the substantially rigid inorganic foam layer includes an interlocking member for interfacing with adjacent panels.

In accordance with one or more aspects of the disclosed embodiment a method of installing a flooring deck system is provided. The method comprises providing a first panel having a first layer of flooring sheet material and a second layer of a rigid foam material configured to support both a static and live load gasped to interact with a floor, providing a second panel having a first layer of flooring sheet material and a second layer of a rigid foam material configured to support both a static and live load gauged to interact with a floor, interlocking the first panel and second panel and engaging the interlocked panels with a basement floor.

In accordance with one or more aspects of the disclosed embodiment, wherein the rigid foam layer is insulating foam.

In accordance with one or more aspects of the disclosed embodiment, wherein the insulating foam is at least one of extruded polystyrene foam (XPS) or expanded polystyrene foam (EPU).

In accordance with one or more aspects of the disclosed embodiment, wherein the insulating foam is at least one of extruded polyurethane foam (XPU) or expanded polyurethane foam (EPU).

In accordance with one or more aspects of the disclosed embodiment, wherein the rigid sheet material is magnesium oxide.

In accordance with one or more aspects of the disclosed embodiment, wherein the panels have global drain and vent channels traversing the bottom.

In accordance with or more aspects of the disclosed embodiment, wherein the panels are interlocked with a tongue and groove.

It should be understood that the foregoing description is only illustrative of the aspects of the disclosed embodiment. Various alternatives and modifications can be devised by those skilled in the art without departing from the aspects of the disclosed embodiment. Accordingly, the aspects of the disclosed embodiment are intended to embrace all such alternatives, modifications and variances that fall within the scope of the appended claims. Further, the mere fact that different features are recited in mutually different dependent or independent claims does not indicate that a combination of these features cannot be advantageously used, such a combination remaining within the scope of the aspects of the invention.

What is claimed is:

1. A flooring deck panel comprising:
a first layer that is a unitary member and is independently substantially impervious to water including a substantially rigid sheet of substantially inorganic material, the first layer having a flooring surface and a joining surface; and
a second layer that is a unitary member and is independently substantially impervious to water and joined to the joining surface of the first layer, the second layer being formed of a substantially inorganic rigid foam material, the second layer being configured as a subfloor support structure, with a walking floor load-bearing capacity, supporting one or more of a static and live load applied to the flooring surface of the first layer.

2. The flooring deck panel of claim 1, wherein the second layer is insulating foam.

3. The flooring deck panel of claim 2, wherein the insulating foam is at least one of extruded polystyrene foam (XPS) or expanded polystyrene foam (EPS).

4. The flooring deck panel of claim 2, wherein the insulating foam is at least one of extruded polyurethane foam (XPU) or expanded polyurethane foam (EPU).

5. The flooring deck panel of claim 1, wherein the first layer is a magnesium oxide sheet.

6. The flooring deck panel of claim 1, wherein the second layer has channels traversing the underside effecting ventilation of air and moisture.

7. The flooring deck panel of claim 6, wherein one of the channels is a merging channel.

8. The flooring deck panel of claim 7, wherein the merging channel traverses along at least one of a perimeter effecting merging of adjacent panel channels creating a continuous channel across all panels.

9. The flooring deck panel of claim 1, wherein the second layer includes an interlocking member for interfacing with adjacent panels.

10. A flooring deck system comprising:
a plurality of panels having at least two layers including a substantially rigid sheet layer of substantially inorganic material that is a unitary member and independently substantially impervious to water and a substantially rigid inorganic foam layer that is a unitary member and independently substantially impervious to water, the substantially rigid sheet layer haying a flooring surface and a joining surface configured to attach to the substantially rigid inorganic foam layer, and the substantially rigid inorganic foam layer haying a connecting surface configured to attach to the joining surface of the substantially rigid sheet layer, and an underside surface configured to contact a foundation floor;
wherein the substantially rigid inorganic foam layer is configured to support both a static and live floor load gauged for a floor.

11. The flooring deck system of claim 10, wherein the substantially rigid inorganic foam layer is insulating foam.

12. The flooring deck system of claim 11, wherein the insulating foam is at least one of extruded polystyrene foam (XPS) or expanded polystyrene foam (EPS).

13. The flooring deck system of claim 11, wherein the insulating foam is at least one of extruded polyurethane foam (XPU) or expanded polyurethane foam (EPU).

14. The flooring deck system of claim 10, wherein the substantially rigid sheet layer is magnesium oxide.

15. The flooring deck system of claim 10, wherein the substantially rigid inorganic foam layer has a global drain and vent channel traversing the underside surface.

16. The flooring deck system of claim 10, wherein the substantially rigid inorganic foam layer includes an interlocking member for interfacing with adjacent panels.

17. A method of installing a flooring deck system, the method comprising:
providing a first panel having a first layer of inorganic flooring sheet material that is a unitary member and independently substantially impervious to water and a second layer of a rigid foam material that is a unitary member and independently substantially impervious to water and configured to support both a static and live load gauged to interact with a floor;
providing a second panel having a first layer of inorganic flooring sheet material that is a unitary member and independently substantially impervious to water and a second layer of a rigid foam material that is a unitary member and independently substantially impervious to water and configured to support both a static and live load gasped to interact with a floor;
interlocking the first panel and second panel; and
engaging the interlocked panels with a basement floor.

18. The method of claim. 17, wherein the second layer is insulating foam.

19. The method of claim 18, wherein the insulating foam is at least one of extruded polystyrene foam (XPS) or expanded. polystyrene foam (EPS).

20. The method of claim 18, wherein the insulating foam is at least one of extruded polyurethane foam (XPU) or expanded polyurethane foam (EPU).

21. The method of claim 17, wherein the first layer is magnesium oxide.

22. The method of claim 17, wherein the first panel and second panel have global drain and vent channels traversing the bottom.

23. The method of claim 17, wherein the first panel and second panel are interlocked with a tongue and groove.
